(19) United States
(12) Patent Application Publication
(10) Pub. No.: US 2018/0301791 A1
(43) Pub. Date: Oct. 18, 2018

(54) ANTENNA MODULE WITH A VERTICAL DIPOLE ANTENNA TO COVER A BROADSIDE RADIATION PATTERN

(71) Applicant: Qualcomm Incorporated, San Diego, CA (US)

(72) Inventors: Zhang JIN, San Diego, CA (US); Jeong II Kim, San Diego, CA (US)

(21) Appl. No.: 15/953,236

(22) Filed: Apr. 13, 2018

Related U.S. Application Data
(60) Provisional application No. 62/486,272, filed on Apr. 17, 2017.

(51) Int. Cl. H01Q 1/24; H01Q 9/18; H01Q 9/26

(52) U.S. Cl. CPC H01Q 1/243; H01Q 9/26; H01Q 9/18

(57) ABSTRACT

Certain aspects of the present disclosure generally relate to wireless communication. In some aspects, an antenna module may include a substrate; a first dipole antenna positioned such that conductive components of the first dipole antenna are oriented on a first plane that is approximately parallel to a mounting surface of the substrate; and a second dipole antenna positioned such that conductive components of the second dipole antenna are oriented on a second plane that is approximately perpendicular to the mounting surface of the substrate, wherein the second dipole antenna is positioned to cover a broadside radiation pattern approximately perpendicular to the mounting surface. Numerous other aspects are provided.

### CROSS-REFERENCE TO RELATED APPLICATIONS UNDER 35 U.S.C. § 119

This application claims priority to U.S. Provisional Patent Application No. 62/486,272, filed on Apr. 17, 2017, entitled “ANTENNA MODULE WITH A VERTICAL DIPOLE ANTENNA TO COVER A BROADSIDE RADIATION PATTERN,” which is hereby expressly incorporated by reference herein.

### FIELD OF THE DISCLOSURE

Aspects of the present disclosure generally relate to wireless communication, and more particularly to an antenna module with a vertical dipole antenna to cover a broadside radiation pattern.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, etc.). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a new radio (NR) BS, a 5G Node B, and/or the like.

The above multiple access technologies have been adopted in various telecommunication standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using OFDM with a cyclic prefix (CP) (CP-OFDM) on the downlink (DL), using CP-OFDM and/or SC-FDM (e.g., also known as discrete Fourier transform spread ODFM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, an antenna module may include a substrate; a first dipole antenna positioned such that conductive components of the first dipole antenna are oriented on a first plane that is approximately parallel to a mounting surface of the substrate; and a second dipole antenna positioned such that conductive components of the second dipole antenna are oriented on a second plane that is approximately perpendicular to the mounting surface of the substrate, wherein the second dipole antenna is positioned to cover a broadside radiation pattern approximately perpendicular to the mounting surface.

In some aspects, a user equipment (UE) for wireless communication may include an antenna module; a first dipole antenna positioned such that conductive components of the first dipole antenna are positioned on a first plane that is approximately parallel to a mounting surface of the antenna module; and a second dipole antenna positioned such that conductive components of the second dipole antenna are positioned on a second plane that is approximately perpendicular to the mounting surface of the antenna module, wherein the second dipole antenna is positioned to cover a broadside radiation pattern for the UE.

In some aspects, an apparatus may include a substrate; and a vertical dipole antenna positioned such that conductive components of the vertical dipole antenna are positioned on a plane that is approximately perpendicular to a mounting surface of the substrate, wherein the vertical dipole antenna is positioned to cover a broadside radiation pattern for the apparatus.

Aspects generally include an antenna module, an apparatus, a system, a user equipment, and a wireless communication device as substantially described herein with reference to and as illustrated by the accompanying drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 shows a block diagram conceptually illustrating an example of a base station in communication with a user equipment (UE) in a wireless communication network, in accordance with various aspects of the present disclosure.

FIG. 3 is a diagram illustrating an example of a vertical dipole antenna, in accordance with various aspects of the present disclosure.

FIG. 4 is a diagram illustrating another example of a vertical dipole antenna, in accordance with various aspects of the present disclosure.

FIG. 5 is a diagram illustrating an example of an antenna module that includes a vertical dipole antenna, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over another aspect. Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, etc. (collectively referred to as “elements”).

An access point (“AP”) may comprise, be implemented as, or known as NodeB, Radio Network Controller (“RNC”), eNodeB (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), Node B (NB), gNB, 5G NB, NR BS, Transmit Receive Point (TRP), or some other terminology.

An access terminal (“AT”) may comprise, be implemented as, or be known as an access terminal, a subscriber station, a subscriber unit, a mobile station, a remote station, a remote terminal, a user terminal, a user agent, a user device, user equipment (UE), a user station, a wireless node, or some other terminology. In some aspects, an access terminal may comprise a cellular telephone, a smart phone, a cordless telephone, a Session Initiation Protocol (“SIP”) phone, a wireless local loop (“WLL”) station, a personal digital assistant (“PDA”), a tablet, a netbook, a smartbook, an ultrabook, a handheld device having wireless connection capability, a Station (“STA”), or some other suitable processing device connected to a wireless modem. Accordingly, one or more aspects taught herein may be incorporated into a phone (e.g., a cellular phone, a smart phone), a computer (e.g., a desktop), a portable communication device, a portable computing device (e.g., a laptop, a personal data assistant, a tablet, a netbook, a smartbook, an ultrabook), wearable device (e.g., smart watch, smart glasses, smart bracelet, smart wristband, smart ring, smart clothing, etc.), medical devices or equipment, biometric sensors/devices, an entertainment device (e.g., music device, video device, satellite radio, gaming device, etc.), a vehicular component or sensor, smart meters/sensors, industrial manufacturing equipment, a global positioning system device, or any other suitable device that is configured to communicate via a wireless or wired medium. In some aspects, the node is a wireless node. A wireless node may provide, for example, connectivity for or to a network (e.g., a wide area network such as the Internet or a cellular network) via a wired or wireless communication link.

Some UEs may be considered machine-type communication (MTC) UEs, which may include remote devices that may communicate with a base station, another remote device, or some other entity. Machine type communications (MTC) may refer to communication involving at least one remote device on at least one end of the communication and may include forms of data communication which involve one or more entities that do not necessarily need human interaction. MTC UEs may include UEs that are capable of MTC communications with MTC servers and/or other MTC devices through Public Land Mobile Networks (PLMN), for example. Examples of MTC devices include sensors, meters, location tags, monitors, drones, robots/robotic devices, etc. MTC UEs, as well as other types of UEs, may be implemented as NB-IoT (narrowband internet of things) devices.

It is noted that while aspects may be described herein using terminology commonly associated with 3G and/or 4G wireless technologies, aspects of the present disclosure can be applied in other generation-based communication systems, such as 5G and later, including NR technologies.

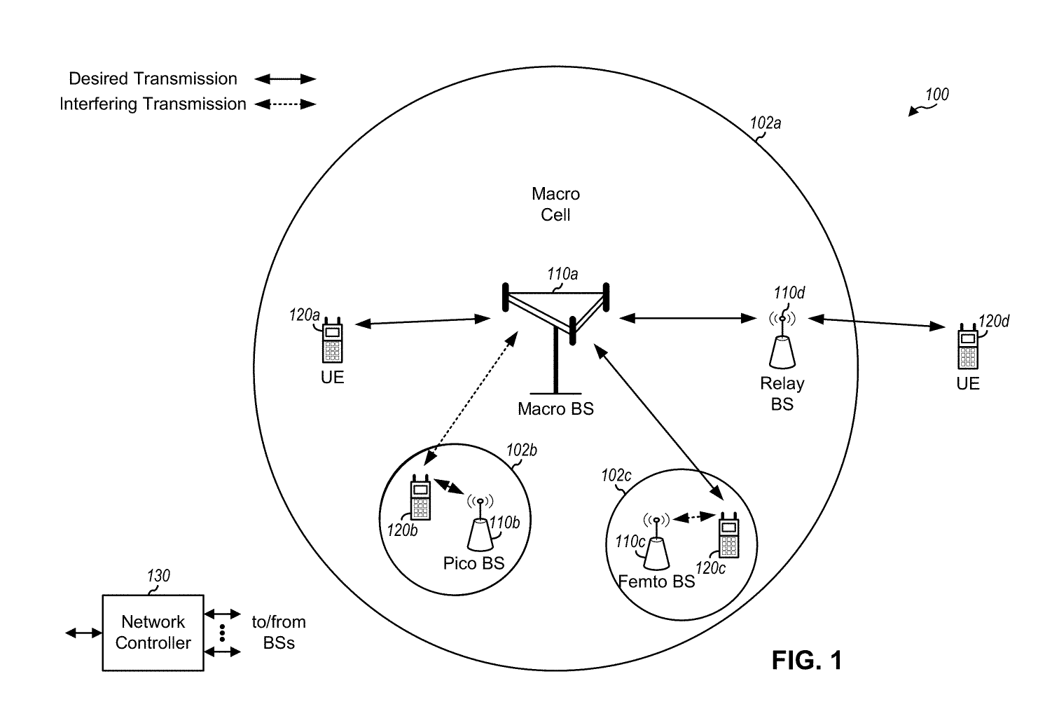

FIG. 1 is a diagram illustrating a network 100 in which aspects of the present disclosure may be practiced. The network 100 may be an LTE network or some other wireless network, such as a 5G or NR network. Wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G NB, an access point, a TRP, etc. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another and/or to one or more other BSs or network nodes (not shown) in the access network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, etc.

Wireless network 100 may be a heterogeneous network that includes BSs of different types, e.g., macro BSs, pico BSs, femto BSs, relay BSs, etc. These different types of BSs may have different transmit power levels, different coverage areas, and different impact on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, etc. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium. In some aspects, a UE 120 may include an antenna module used to communicate with a BS 110. Such antenna module may include dipole antennas positioned in different orientations, as described in more detail elsewhere herein. For example, the antenna module may include a first dipole antenna positioned approximately parallel to a mounting surface of the antenna module and a second dipole antenna positioned approximately perpendicular to the mounting surface of the antenna module.

Some UEs may be considered evolved or enhanced machine-type communication (eMTC) UEs. MTC and eMTC UEs include, for example, robots, drones, remote devices, such as sensors, meters, monitors, location tags, etc., that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices. Some UEs may be considered a Customer Premises Equipment (CPE). UE 120 may be included inside a housing that houses components of UE 120, such as processor components, memory components, and/or the like.

In FIG. 1, a solid line with double arrows indicates desired transmissions between a UE and a serving BS, which is a BS designated to serve the UE on the downlink and/or uplink. A dashed line with double arrows indicates potentially interfering transmissions between a UE and a BS.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

As indicated above, FIG. 1 is provided merely as an example. Other examples are possible and may differ from what was described with regard to FIG. 1.

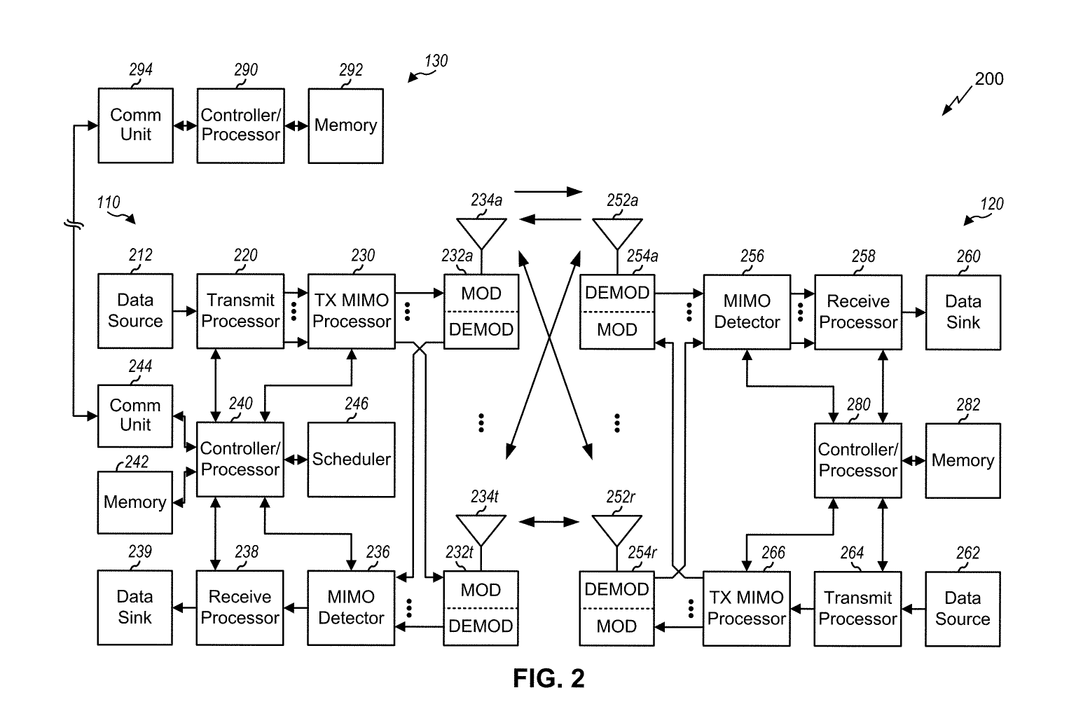

FIG. 2 shows a block diagram 200 of a design of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1. One or more antennas described herein may be implemented as a dipole antenna (e.g., a horizontal dipole antenna, a vertical dipole antenna, etc.) in an antenna module of the UE 120, as described in more detail elsewhere herein.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI), etc.) and control information (e.g., CQI requests, grants, upper layer signaling, etc.) and provide overhead symbols and control symbols. Transmit processor 220 may also generate reference symbols for reference signals (e.g., the CRS) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. A scheduler 246 may schedule UEs for data transmission on the downlink and/or uplink.

At UE 120, antennas 252a through 252r (e.g., which may be implemented in an antenna module of UE 120) may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine RSRP, RSSI, RSRQ, CQI, etc.

On the uplink, at UE 120, a transmit processor 264 may receive and process data from a data source 262 and control information (e.g., for reports comprising RSRP, RSSI, RSRQ, CQI, etc.) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, etc.), and transmitted to base station 110 (e.g., using one or more antennas 252a through 252r, which may be implemented in an antenna module). At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292. In some aspects, one or more components of UE 120 may be included in a housing.

Controllers/processors 240 and 280 and/or any other component(s) in FIG. 2 may direct the operation at base station 110 and UE 120, respectively. Memories 242 and 282 may store data and program codes for base station 110 and UE 120, respectively. In some aspects, one or more components of UE 120 may be implemented on an antenna module, such as one or more antennas 252a through 252r and one or more integrated circuits used to perform the functions described herein in connection with, for example, modulators and/or demodulators 254a through 254r, MIMO detector 256, receive processor 258, transmit processor 264, TX MIMO processor 266, and/or the like.

As indicated above, FIG. 2 is provided merely as an example. Other examples are possible and may differ from what was described with regard to FIG. 2.

In some UE designs, a patch antenna may be used to cover a radiation pattern in a particular direction, such as a broadside radiation pattern (e.g., a radiation pattern substantially perpendicular to the backside of the UE). However, a patch antenna may require a thick substrate, which limits how thin an antenna module, that includes the patch antenna, can be. This also limits how thin the UE can be. Furthermore, an antenna module with a thicker substrate is more expensive to produce than an antenna module with a thinner substrate. Aspects described herein use a vertical dipole antenna to cover a broadside radiation pattern, thereby permitting thinner antenna modules and UEs and reducing a cost of producing the antenna module.

In some aspects, using a vertical dipole antenna instead of a patch antenna may reduce the thickness of the antenna module by half or more. As UEs are used for more applications (e.g., MTC UEs, IoT UEs, etc.), a thinner design may permit a UE to be used for new applications. Furthermore, a vertical dipole antenna may have other advantages over a patch antenna, such as better electromagnetic isolation properties, increased design flexibility due to a smaller size, more flexibility in designing resonant frequency and bandwidth coverage, and/or the like.

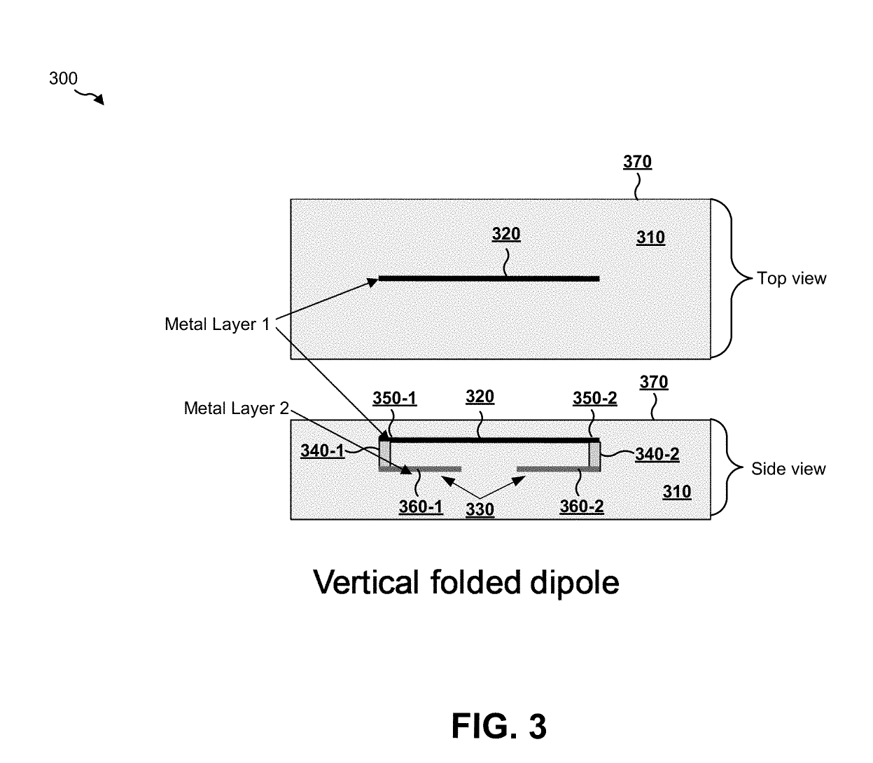

FIG. 3 is a diagram illustrating an example 300 of a vertical dipole antenna, in accordance with various aspects of the present disclosure. FIG. 3 shows a top view and a side view of a vertical dipole antenna formed by performing semiconductor fabrication techniques (e.g., photolithography, chemical processing, etching, material deposition, and/or the like) on multiple layers of a substrate 310 to form a semiconductor device 370.

As shown in FIG. 3, a vertical dipole antenna may be formed by performing one or more semiconductor fabrication techniques on multiple layers of a substrate 310 (whereas a horizontal dipole antenna may be formed by performing one or more semiconductor fabrication techniques on a single layer of a substrate). For example, a first portion 320 of the vertical dipole antenna may be formed on a first layer of the substrate 310, and a second portion 330 of the vertical dipole antenna may be formed on a second layer of the substrate 310 (e.g., by performing fabrication techniques on these respective layers). As further shown, the first portion 320 and the second portion 330 may be connected using one or more vias 340 (e.g., shown as a first via 340-1 and a second via 340-2) that extend from the first layer of the substrate 310 to the second layer of the substrate 310 and electrically connect the first portion 320 and the second portion 330.

In some aspects, the dipole antenna formed by performing the fabrication techniques on multiple layers of the substrate 310 is a folded dipole antenna. In this case, the first portion 320 may include a single segment of material (e.g., a conductive material, such as metal) and the second portion 330 may include two segments of material separated by an insulating material of the substrate 310, as shown. In some aspects, the second portion 330 may act as an antenna feed and/or may connect to an antenna feed. As further shown, a first via 340-1 may connect a first end 350-1 of the first portion 320 to a first segment 360-1 of the second portion 330, and a second via 340-2 may connect a second end of 350-2 the first portion 320 to a second segment 360-2 of the second portion 330, thereby forming the conductive material in the shape of the folded dipole antenna. In FIG. 3, the first portion 320, the second portion 330, and the vias 340 may be composed of conductive material, and the remainder of the substrate 310 may be composed of insulating material. Furthermore, FIG. 3 shows a conceptual view, where an antenna feed is not shown. The antenna feed may electrically connect to the first segment 360-1 and the second segment 360-2 of the second portion 330.

As shown, the first portion 320 may be longer than the first segment 360-1, and may be substantially parallel to the first segment 360-1 (e.g., within a tolerance threshold). Similarly, the first portion 320 may be longer than the second segment 360-2, and may be substantially parallel to the second segment 360-2 (e.g., within a tolerance threshold). As further shown, the first portion 320 may be continuous, while the first segment 360-1 and the second segment 360-2 may be separated from one another by an insulating material. Furthermore, the first portion 320 may be separated from the first segment 360-1 and the second segment 360-2 by an insulating material except for at the first end 350-1 of the first portion 320, which is electrically connected to an end of the first segment 360-1 by the first via 340-1, and at the second end 350-2 of the first portion 320, which is electrically connected to an end of the second segment 360-2 by the second via 340-2.

While FIG. 3 shows an example of a vertical folded dipole antenna, other types of dipole antennas may be used, such as a bowtie dipole antenna and/or the like. Furthermore, FIG. 3 is provided merely as an example. Other examples are possible and may differ from what was described with regard to FIG. 3.

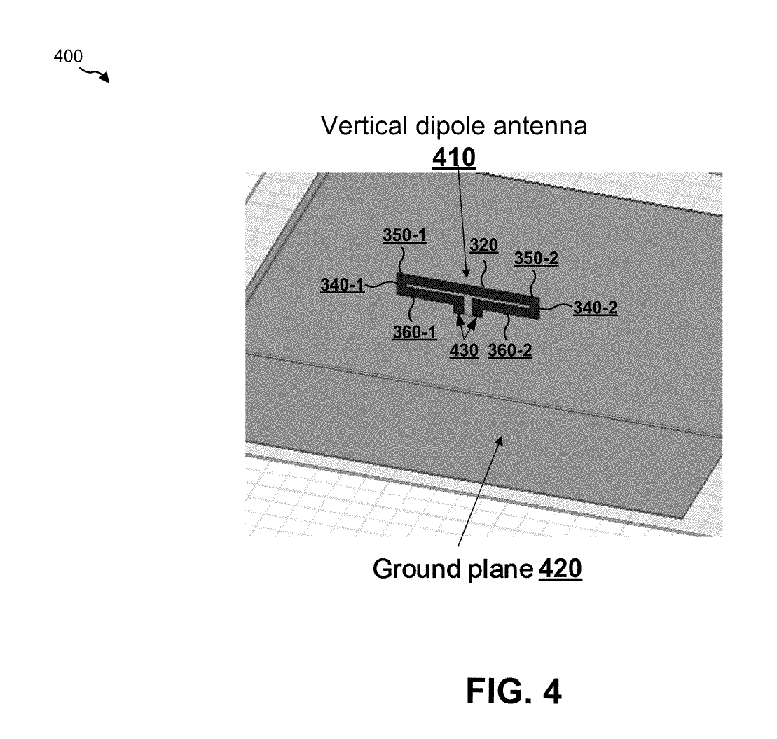

FIG. 4 is a diagram illustrating another example 400 of a vertical dipole antenna, in accordance with various aspects of the present disclosure. FIG. 4 shows a conceptual view of the antenna of FIG. 3, without showing layers of the substrate 310 from which the antenna is formed by performing a series of semiconductor fabrication techniques.

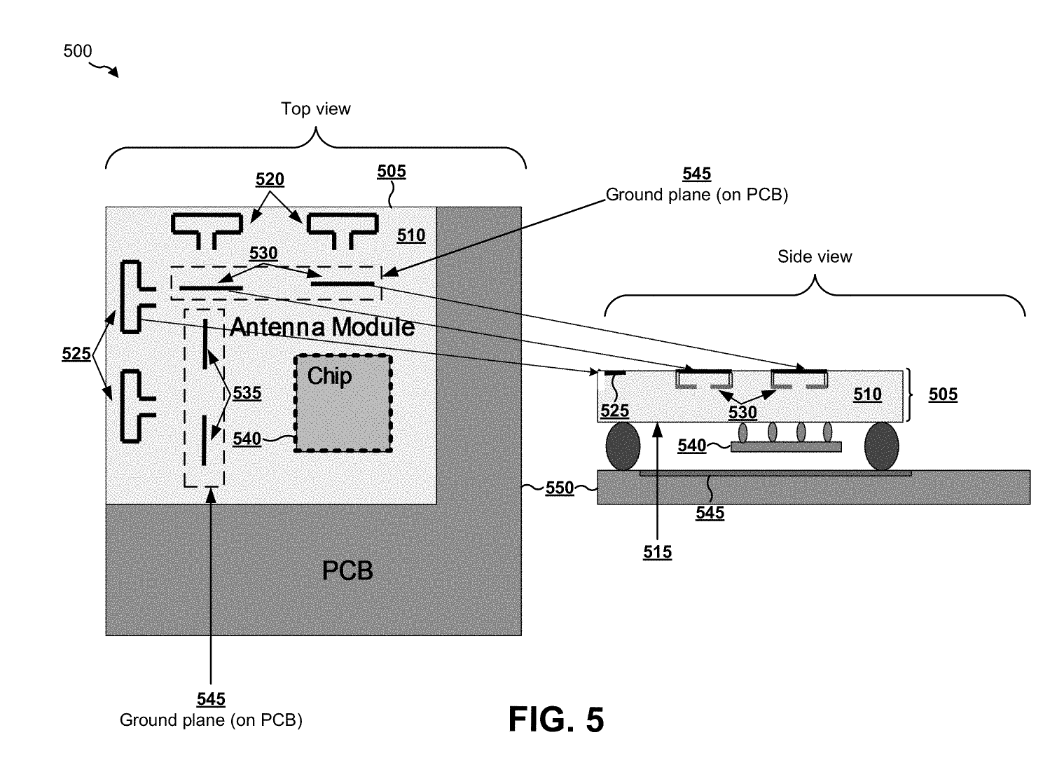

As shown in FIG. 4, a vertical dipole antenna 410 (e.g., as described above in connection with FIG. 3) may be positioned substantially perpendicular to a ground plane 420. In some aspects, the ground plane 420 is physically separate from an antenna module that includes the vertical dipole antenna 410. Additionally, or alternatively, the ground plane 420 may be integrated into a printed circuit board upon which the antenna module is to be mounted. As shown, an antenna feed 430 may electrically connect to the first segment 360-1 and the second segment 360-2 of the second portion 330. Additional details regarding the vertical dipole antenna 410, the ground plane 420, and the antenna module are provided below in connection with FIG. 5. FIG. 4 is intended to show the orientation of the antenna 410 with respect to the ground plane 420.

As indicated above, FIG. 4 is provided merely as an example. Other examples are possible and may differ from what was described with regard to FIG. 4.

FIG. 5 is a diagram illustrating an example 500 of an antenna module that includes a vertical dipole antenna, in accordance with various aspects of the present disclosure. FIG. 5 shows a top view and a side view of an antenna module 505 (e.g., which may be a semiconductor device). The views shown in FIG. 5 are intended as 0097-0262 17 conceptual views, and the side view shown in FIG. 5 is not intended to illustrate a particular cross-section of the top view. Furthermore, some features of the antenna module 505, such as antenna feeds (e.g., to connect the antennas to an integrated circuit), are not shown.

As shown in FIG. 5, the antenna module 505 may include a substrate 510, which may be made of a package material, such as FR-4, Pre-preg, and/or the like. In some aspects, the antenna module 505 may include a first set of (e.g., one or more) dipole antennas positioned approximately parallel to (e.g., within a threshold tolerance range) a mounting surface 515 of the substrate 510. In some aspects, the first set of dipole antennas are horizontal dipole antennas, shown as horizontal dipole antennas 520 with a first orientation (e.g., to cover a first radiation pattern) and horizontal dipole antennas 525 with a second orientation (e.g., to cover a second radiation pattern). In some aspects, the second orientation may be substantially orthogonal to the first orientation. The antennas 520 and 525 may be formed on a single layer (e.g., a metal layer) of the substrate 510. Furthermore, each of the antennas 520 and 525 (e.g., each horizontal dipole antenna) may be oriented on a plane that is approximately parallel to the mounting surface 515. For example, all conductive components of an individual horizontal dipole antenna may lie on a plane that is approximately parallel to the mounting surface 515.

In a similar manner as described above in connection with FIG. 3 with respect to a vertical dipole antenna, and as shown in FIG. 5, a horizontal dipole antenna may include a first portion (e.g., a long portion) that is longer than a first segment of a second portion (e.g., a first segment that connects to an antenna feed) and that is substantially parallel to the first segment (e.g., within a tolerance threshold). Similarly, the first portion (e.g., the long portion) may be longer than a second segment of the second portion (e.g., a second segment that connects to an antenna feed) and that is substantially parallel to the second segment (e.g., within a tolerance threshold). As further shown in FIG. 5, the first portion (e.g., the long portion) may be continuous, while the first segment and the second segment may be separated from one another by an insulating material (e.g., of the substrate 510). Furthermore, the first portion may be separated from the first segment and the second segment by an insulating material except for at a first end of the first portion, which is electrically connected (e.g., by a first electrical connection component, such as a first conductive material) to an end of the first segment (not by a via), and at a second end of the first portion, which is electrically connected (e.g., by a second electrical connection component, such as a second conductive material) to an end of the second segment (not by a via).

Additionally, or alternatively, the antenna module 505 may include a second set of (e.g., one or more) dipole antennas positioned approximately perpendicular to (e.g., within a threshold tolerance range) the mounting surface 515 of the substrate 510. In some aspects, the second set of dipole antennas are vertical dipole antennas, shown as vertical dipole antennas 530 with a third orientation (e.g., to cover a third radiation pattern) and vertical dipole antennas 535 with a fourth orientation (e.g., to cover a fourth radiation pattern). In some aspects, the third orientation may be substantially orthogonal to the fourth orientation. The antennas 530 and 535 may be formed by performing a series of semiconductor fabrication techniques on multiple layers of the substrate 510, as described above in connection with FIG. 3. For example, the antennas 530 and 535 may be the antenna shown in FIG. 3 and/or FIG. 4. Furthermore, each of the antennas 530 and 535 (e.g., each vertical dipole antenna) may be oriented on a plane that is approximately perpendicular to the mounting surface 515. For example, all conductive components of an individual vertical dipole antenna (e.g., the first portion 320, the second portion 330, and the vias 340) may lie on a plane that is approximately perpendicular to the mounting surface 515.

In some aspects, each of the first, second, third, and fourth orientations may be substantially orthogonal to one another, as shown in FIG. 5. In some aspects, one or more of the second set of dipole antennas may be positioned to cover a broadside radiation pattern that is approximately perpendicular to the mounting surface 515. By using one or more vertical dipole antennas rather than patch antennas to cover a broadside radiation pattern, a thickness of the antenna module 505 may be reduced, thereby reducing manufacturing costs and permitting thinner UEs.

As shown in FIG. 5, and as described above in connection with FIG. 3, in some aspects, a first portion of a vertical dipole antenna of the antenna module is formed on a first layer of the substrate 510, and a second portion of the vertical dipole antenna is formed on a second layer of the substrate 510. In some aspects, the first portion and the second portion are connected using one or more vias that extend through the substrate 510 from the first layer to the second layer. For example, each end of the first portion and the second portion may be connected using a via to form the shape of a folded dipole antenna. Thus, in some aspects, the vertical dipole antenna(s) may be formed on multiple layers of the substrate 510. In some aspects, the horizontal dipole antenna(s) may be formed on a single layer of the substrate 510.

As further shown in FIG. 5, the mounting surface 515 may include a surface of the antenna module 505 and/or the substrate 510 upon which one or more integrated circuits 540 (e.g., a chip and/or the like) are to be mounted (e.g., using solder balls, as shown, or another mounting mechanism). For the sake of simplicity, the antenna feeds that connect the antennas 520, 525, 530, and 535 to the integrated circuit 540 are not shown. Further, the integrated circuit 540 shown in the top view is illustrated using a dashed line because the chip is positioned between the antenna module 505 and the printed circuit board. Integrated circuit 540 may include, for example, one or more components of a UE 120 described above in connection with FIG. 2, such as one or more integrated circuits used to perform the functions described herein in connection with, for example, modulators and/or demodulators 254a through 254r, MIMO detector 256, receive processor 258, transmit processor 264, TX MIMO processor 266, and/or the like. Additionally, or alternatively, antennas 520, 525, 530, and/or 535 may include, for example, one or more antennas 252a through 252r of FIG. 2.

In some aspects, a ground plane 545 associated with the vertical dipole antenna(s) may be separate from (e.g., may not be included in) the antenna module 505. The ground plane 545 may be a conducting surface, connected to a ground wire, that reflects radio waves (e.g., to prevent or reduce electromagnetic radiation entering the human body). In some aspects, the ground plane 545 may be integrated into a printed circuit board 550 upon which the antenna module is to be mounted (e.g., using solder balls, as shown, or another mounting mechanism). By separating the ground plane 545 from the antenna module 505, a thickness of the antenna module 505 may be further reduced, thereby reducing manufacturing costs and permitting thinner UEs.

In some aspects, the vertical dipole antenna(s) and corresponding ground plane(s) may be positioned so that a surface area of the integrated circuit(s) 540 does not lie between the vertical dipole antenna(s) and the corresponding ground plane(s), as shown by the top view in FIG. 5. The side view of FIG. 5 is a conceptual two-dimensional view, and the integrated circuit 540 is positioned in three-dimensional space such that the integrated circuit 540 does not lie between the vertical dipole antenna(s) and the corresponding ground plane(s). For example, as shown by the dotted lines surrounding vertical dipole antennas 530 and vertical dipole antennas 535 in FIG. 5, the ground planes 545 may be positioned to reflect a back lobe of a radiation pattern produced by the vertical dipole antennas 530, 535. In this way, electromagnetic interference with integrated circuit(s) 540 may be reduced.

Although FIG. 5 shows a particular combination of types of dipole antennas (e.g., horizontal and vertical folded dipole antennas), a particular number of dipole antennas (e.g., four horizontal dipole antennas, four vertical dipole antennas, and eight total antennas), and particular orientations of dipole antennas (e.g., two horizontal dipole antennas with a first orientation, two horizontal dipole antennas with a second orientation, two vertical dipole antennas with a third orientation, and two vertical dipole antennas with a fourth orientation), the actual types, numbers, and/or orientations of antennas used in antenna module 505 may differ from what is shown in connection with FIG. 5 in some aspects.

As indicated above, FIG. 5 is provided merely as an example. Other examples are possible and may differ from what was described with regard to FIG. 5.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. An antenna module, comprising:
a substrate;
a first dipole antenna positioned such that conductive components of the first dipole antenna are oriented on a first plane that is approximately parallel to a mounting surface of the substrate; and
a second dipole antenna positioned such that conductive components of the second dipole antenna are oriented on a second plane that is approximately perpendicular to the mounting surface of the substrate, wherein the second dipole antenna is positioned to cover a broadside radiation pattern approximately perpendicular to the mounting surface.

2. The antenna module of claim 1, wherein a first portion of the second dipole antenna is formed on a first layer of the substrate, and wherein a second portion of the second dipole antenna is formed on a second layer of the substrate, wherein the first portion and the second portion are separated by an insulating material.

3. The antenna module of claim 2, wherein the first portion and the second portion are connected using one or more vias.

4. The antenna module of claim 1, wherein the first dipole antenna is formed on a single layer of the substrate, and wherein the second dipole antenna is formed on multiple layers of the substrate.

5. The antenna module of claim 1, wherein the antenna module does not include a ground plane associated with the second dipole antenna.

6. The antenna module of claim 1, wherein the second dipole antenna is a folded dipole antenna.

7. The antenna module of claim 1, wherein the first dipole antenna is a folded dipole antenna.

8. The antenna module of claim 1, wherein the conductive components of the second dipole antenna include a first portion, a first segment of a second portion, a second segment of the second portion, a first via that electrically connects the first portion and the first segment, and a second via that electrically connects the first portion and the second segment, wherein the first portion is longer than and substantially parallel to the first segment, and wherein the first portion is longer than and substantially parallel to the second segment.

9. The antenna module of claim 1, wherein the conductive components of the first dipole antenna include a first portion, a first segment of a second portion, a second segment of the second portion, a conductive material that electrically connects the first portion and the first segment, and a conductive material that electrically connects the first portion and the second segment, wherein the first portion is longer than and substantially parallel to the first segment, and wherein the first portion is longer than and substantially parallel to the second segment.

10. A user equipment (UE) for wireless communication, comprising:
an antenna module;
a first dipole antenna positioned such that conductive components of the first dipole antenna are positioned on a first plane that is approximately parallel to a mounting surface of the antenna module; and
a second dipole antenna positioned such that conductive components of the second dipole antenna are positioned on a second plane that is approximately perpendicular to the mounting surface of the antenna module, wherein the second dipole antenna is positioned to cover a broadside radiation pattern for the UE.

11. The UE of claim 10, wherein a first portion of the second dipole antenna is formed on a first layer of a substrate, and wherein a second portion of the second dipole antenna is formed on a second layer of the substrate.

12. The UE of claim 11, wherein the first portion and the second portion are connected using one or more vias.

13. The UE of claim 10, wherein the first dipole antenna is formed on a single layer of a substrate, and wherein the second dipole antenna is formed on multiple layers of the substrate.

14. The UE of claim 10, wherein the antenna module does not include a ground plane associated with the second dipole antenna.

15. The UE of claim 14, wherein the ground plane is integrated into a printed circuit board upon which the antenna module is to be mounted.

16. The UE of claim 15, wherein the second dipole antenna and the ground plane are positioned so that a surface area of an integrated circuit, to be mounted to the mounting surface of the antenna module, does not lie between the second dipole antenna and the ground plane.

17. The UE of claim 10, wherein the second dipole antenna is a folded dipole antenna.

18. The UE of claim 10, wherein the first dipole antenna is a folded dipole antenna.

19. The UE of claim 10, wherein the conductive components of the second dipole antenna include a first portion, a first segment of a second portion, a second segment of the second portion, a first via that electrically connects the first portion and the first segment, and a second via that electrically connects the first portion and the second segment, wherein the first portion is longer than and substantially parallel to the first segment, and wherein the first portion is longer than and substantially parallel to the second segment.

20. The UE of claim 10, wherein the conductive components of the first dipole antenna include a first portion, a first segment of a second portion, a second segment of the second portion, a conductive material that electrically connects the first portion and the first segment, and a conductive material that electrically connects the first portion and the second segment, wherein the first portion is longer than and substantially parallel to the first segment, and wherein the first portion is longer than and substantially parallel to the second segment.

21. An apparatus, comprising:
a substrate; and
a vertical dipole antenna positioned such that conductive components of the vertical dipole antenna are positioned on a plane that is approximately perpendicular to a mounting surface of the substrate, wherein the vertical dipole antenna is positioned to cover a broadside radiation pattern for the apparatus.

22. The apparatus of claim 21, wherein the conductive components of the vertical dipole antenna include a first portion, a first segment of a second portion, a second segment of the second portion, a first via that electrically connects the first portion and the first segment, and a second via that electrically connects the first portion and the second segment, wherein the first portion is longer than and substantially parallel to the first segment, and wherein the first portion is longer than and substantially parallel to the second segment.

23. The apparatus of claim 21, further comprising a horizontal dipole antenna positioned such that conductive components of the horizontal dipole antenna are positioned on a plane that is approximately parallel to the mounting surface of the substrate.

24. The apparatus of claim 23, wherein the conductive components of the horizontal dipole antenna include a first portion, a first segment of a second portion, a second segment of the second portion, a conductive material that electrically connects the first portion and the first segment, and a conductive material that electrically connects the first portion and the second segment, wherein the first portion is longer than and substantially parallel to the first segment, and wherein the first portion is longer than and substantially parallel to the second segment.

25. The apparatus of claim 21, wherein a first portion of the vertical dipole antenna is formed on a first layer of the substrate, and wherein a second portion of the vertical dipole antenna is formed on a second layer of the substrate.

26. The apparatus of claim 25, wherein the first portion and the second portion are connected using one or more vias.

27. The apparatus of claim 21, wherein the apparatus does not include a ground plane associated with the vertical dipole antenna.

28. The apparatus of claim 21, wherein the vertical dipole antenna is positioned so that a surface area of an integrated circuit, to be mounted to the mounting surface of the substrate, does not lie between the vertical dipole antenna and a ground plane.

29. The apparatus of claim 21, wherein the vertical dipole antenna is a folded dipole antenna.

30. The apparatus of claim 21, wherein the vertical dipole antenna is included in a plurality of vertical dipole antennas positioned approximately perpendicular to the mounting surface of the substrate.
